(19) United States
(12) Patent Application Publication
(10) Pub. No.: US 2014/0310078 A1
(43) Pub. Date: Oct. 16, 2014

(54) METHOD AND SYSTEM FOR PROVIDING A LOYALTY PROGRAM

(71) Applicant: SHOPITIZE LIMITED, Londo Greater London (GB)

(72) Inventors: Alexey Andriyanenko, London (GB); Irina Pafomova, London (GB); Alan Griffiths Gordon, Queensland (AU); Alexander Mikhalev, Swindon Wiltshire (GB); Michael Murphree Bullion, London (GB)

(21) Appl. No.: 14/352,498

(22) PCT Filed: Oct. 12, 2012
(86) PCT No.: PCT/GB2012/052575

§ 371 Date: Apr. 17, 2014

(30) Foreign Application Priority Data
Oct. 18, 2011 (GB) 1117912.4

(51) Int. Cl. G06Q 30/02; G06Q 30/06

(52) U.S. Cl. CPC G06Q 30/0226; G06Q 30/0212; G06Q 30/0625
USPC 705/14.14; 705/14.27; 705/26.62

(57) ABSTRACT

The present invention relates to a method and system for providing a loyalty program. The method includes a user providing access to a server to a plurality of receipts from a plurality of providers. The server processes the receipts in order to generate benefits for the user.

### FIELD OF INVENTION

The present invention is in the field of providing loyalty programs. Particularly, but not exclusively, the present invention relates to a method and system for providing a loyalty program across multiple providers of products and services, as well as the retail channels that sell those products and/or services.

### BACKGROUND

A traditional loyalty program has three key characteristics: (1) a retailer of goods or services; (2) a unique account number for a consumer; and (3) association of an account number with a purchase or consumption of service.

For retailers, loyalty programs are typically tied to the specific retailer as a way to better track what purchases were made by a specific consumer. Accordingly, there has been little to no incentive for competing retailers to share information about consumers they are both trying to attract. This generally applies to service providers as well.

Loyalty programs are predicated on the ability to identify customers to a specific transaction. Accordingly, the provision of a unique customer identification or account number is a key element of any loyalty system. In more sophisticated systems, customers apply for accounts providing a variety of demographic and preference data about themselves or their families. The retailer then either generates, or assigns a pre-generated account number, to which the customer is then associated and tracked by the retailer's database. This account number is usually provided on a plastic card with either a magnetic strip or bar code which contains the account number. In less sophisticated systems, the customer may be completely anonymous. An example of such system would be a paper card (e.g. from a local coffee shop), with spaces to denote number of purchases.

Data association typically takes place at the point of sale or service consumption. In the case of a supermarket, a customer produces a retailer-provided card, for which they have applied. The card is scanned into the retailer's point of sale (POS), reading the magnetic strip or barcode as if it were a purchased product. At this point the customer's card number is then associated with items purchased. Similarly, for service providers (e.g. airlines), a card is produced shortly before service consumption (i.e. boarding the flight). In the case of an airline, an agent either swipes the customer's plastic flyer card or manually enters the number into the customer's flight record, thus associating the flight and the customer. In less sophisticated systems, the service provider's paper card is marked (usually via special stamp or hole punch) to denote a purchase.

In a few instances, loyalty programs have been created that span across providers. One example is that of credit cards rewards which accumulate for purchasing goods or services with a specific card. However, credit card based programs are better characterized as loyalty to one service provider—the credit card company itself. Another example is that of Nectar (http://www.nectar.com). Nectar enables collection of reward points across a variety of retailers and service providers. (http://www.nectar.com/collect.points). Generally, this network consists of retailers and service providers who offer complementary as opposed to competing goods and services.

For product manufacturers the primary disadvantage of existing loyalty programs is lack of visibility of granular data. Because loyalty schemes are designed to be a competitive advantage in managing the retailer's business, product manufacturers, by definition have reduced access. Accordingly, data for sales of their products, while captured at retail POS terminals, is only repackaged and sold back to product manufacturers in aggregate or summary form. The inability to access data at the individual level makes it difficult for product manufacturers to understand and impact consumer behaviour at an individual rather than at an aggregate level.

Further, because existing loyalty programs relate to specific retailers, product manufacturers are unable to observe and influence behaviour that takes place across multiple retailers (i.e. an individual purchasing the same product from difference retailers, at different times, locations etc.)

For consumers, the key disadvantages of existing loyalty programs relate to convenience, visibility and portability. First, the plethora of existing loyalty programs requires customers to sign-up for, manage and remember to register their purchases with a specific retailer.

Because of the fragmentation in loyalty programs, the consumer never has a complete picture of their purchases outside of a specific retailer.

Additionally, existing loyalty programs are closed systems that require accumulated rewards to be spent within the specific retailer or service provider's network. This greatly limits the amount of choice consumer have in where to redeem their rewards.

It is an object of the present invention to provide a method and system for providing a loyalty program which overcomes the disadvantages of the prior art, or at least provides a useful choice.

### SUMMARY OF INVENTION

According to a first aspect of the invention there is provided a computer-implemented method of providing a loyalty program, including:
a first user providing access to a server for a plurality of receipts from a plurality of providers; and
the server processing the plurality of receipts to generate a benefit for the first user.

According to a further aspect of the invention there is provided a system of providing a loyalty program, including:
a first user device configured to provide access to a server for a plurality of receipts from a plurality of providers; and
a server configured to process the plurality of receipts to generate a benefit for the first user.

Other aspects of the invention are described within the claims.

### BRIEF DESCRIPTION OF THE DRAWINGS

Embodiments of the invention will now be described, by way of example only, with reference to the accompanying drawings in which:

FIG. 1: shows a block diagram illustrating a system in accordance with an embodiment of the invention;

FIG. 2: shows a flowchart illustrating a method in accordance with an embodiment of the invention;

FIG. 3: shows a flowchart illustrating a method for a product code matching system in accordance with an embodiment of the invention;

FIG. 4: shows a diagram illustrating ensemble clustering in accordance with an embodiment of the invention; and

FIG. 5: shows a flowchart illustrating a method for consumption calculation system in accordance with an embodiment of the invention.

### DETAILED DESCRIPTION OF PREFERRED EMBODIMENTS

The present invention provides a method and system for providing a loyalty program via a communications network.

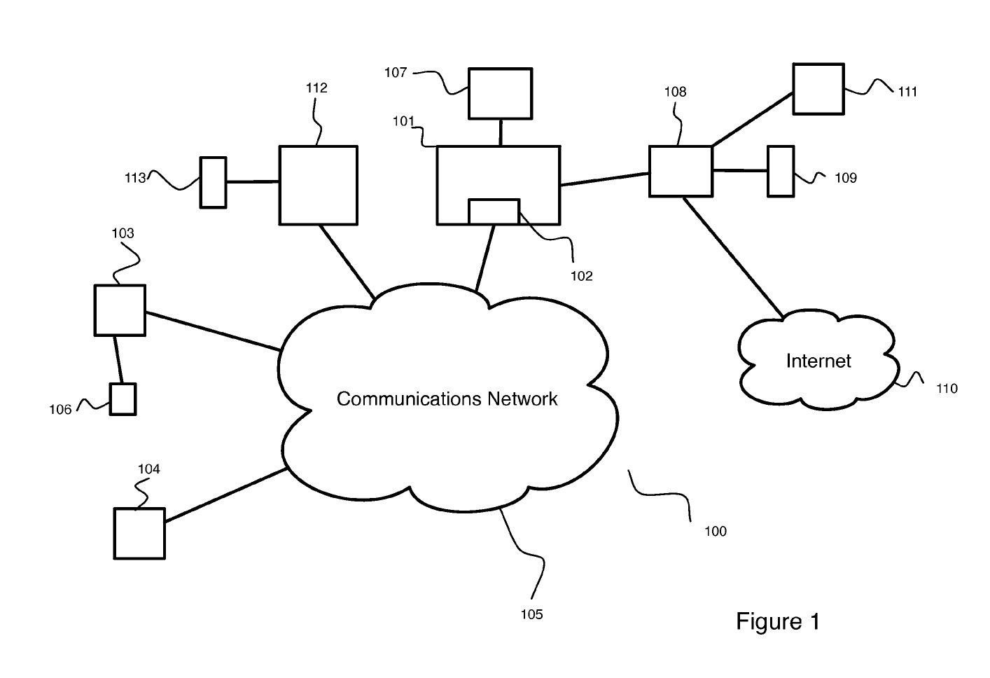

In FIG. 1, a system 100 for providing a loyalty program is shown. The system 100 includes a server 101. The server 101 includes a communications network interface 102 for communicating with a plurality of user devices 103 and 104 via a communications network 105. The communications network 105 may be the Internet.

The user devices 103 and 104 may be mobile devices, such as cellular mobile telephones or tablet computers, or computing devices, such as laptop or desktop computers. It will be appreciated that other devices with a processor, memory, user interface and communications interface may be used as a user device.

One of the user devices 103 may interface with a capture device 106 such as an external/internal camera, or scanner. The interface may be an indirect interface, for example, with an external camera via the memory card of the external camera within a memory card reader. The capture device 106 may be configured for capturing electronic images of physical receipts.

The server 101 may interface with an image processing system 107 and a product code matching system 108. The image processing system 107 may be configured for converting images of receipts to electronically readable versions of the receipts. The electronically readable versions of the receipts preferably includes product codes. The product code matching system 108 may be configured for matching the product codes extracted from the electronically readable versions of the receipts to universal product codes. The product code matching system 108 may interface with a database 109, the Internet 110, and/or a verification user device 111.

A third party server 112 interfaced with a database 113 may also be connected to the communications network 105. The third party database 113 may be configured for storing electronic receipts. The electronic receipts may be in an electronically readable format, such as XML (eXtensible Mark-up Language) or CSV (Comma-Separated Values).

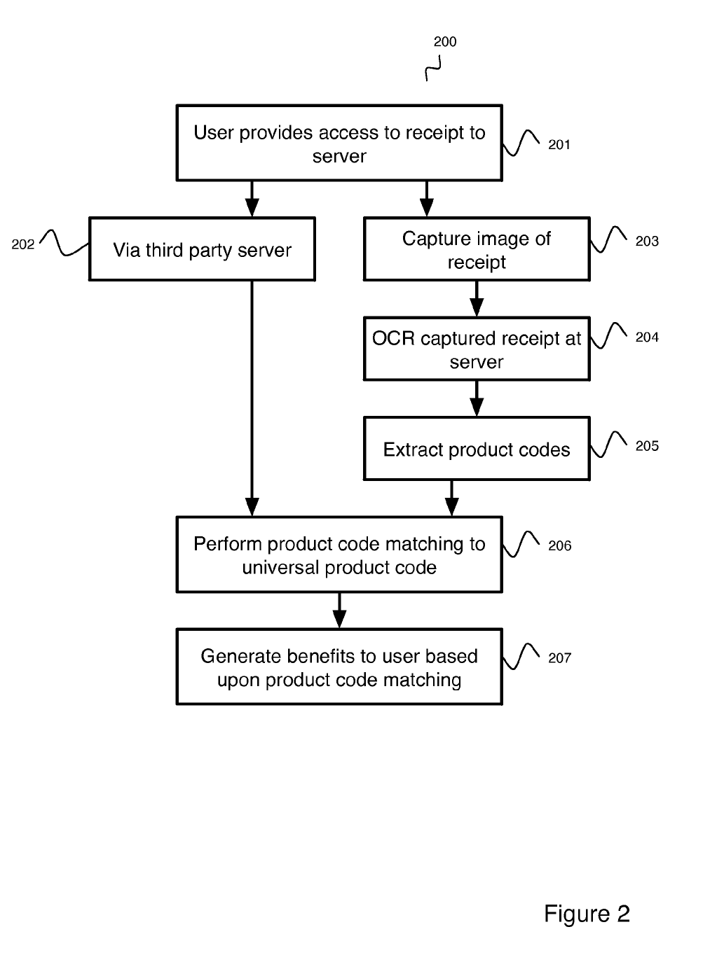

With reference to FIG. 2, a method 200 for providing a loyalty program will be described.

A user utilising one of the user devices 103 or 104 provides access to the server 101 in step 201 to a plurality of receipts for purchases from a plurality of providers. The providers may be seller of goods and/or services such as a retailer.

The user may provide access to the server by authorising access to a digitised version of the receipt in step 202. The digitised version of the receipt may have been generated by the provider and may be stored on a third party server, such as a provider server, the user's email server, or a user's accounting system.

Alternatively, the user may provide access to the server by performing the following steps:
a) using a capture device 106 to capture an image of the receipt in step 203; and
b) uploading the captured image to the server 101 using their user device 103 in step 204.

In this case, the server 101 may further process the captured image using the image processing system 107 to extract information, such as product codes, from the captured image in step 205.

The image processing system 107 may perform optical character recognition (OCR) on the captured image to recognise the text within the image and to extract certain information.

The certain information may include product codes for the purchases recorded on the receipt, names of the products purchased, location information, provider/retailer information, and temporal information (date/time of purchase).

Providers often utilise different product codes from one another for the same product. The server 101 may utilise the product code matching system 108 to map the product code to a universal product code in step 206. The product code matching system 108 may utilise the following steps:
1) A semantic search is performed on the Internet 110 using the product code to identify a long product name;
2) The paired product code and long product name are stored within a database;
3) The server 101 provides an interface to facilitate human user verification and/or customer verification of the pairing;
4) A semantic search is performed on a universal product code (UPC) database 109 using the long product name; and
5) The server 101 provides an interface to facilitate human user verification and/or customer verification of the UPC semantic search.

For example, a customer purchases Alpha Cola from supermarket A. His receipts denotes this as “AlCola 24/12 oz pk £6.99”. Later he buys another Alpha Cola from supermarket B. This receipts denotes the purchase as “AlpColaCh 2 L £1.99”. Internet searches take place for both products and a matching algorithm utilised by the product code matching system 108 suggests that the first purchase is likely “Alpha Cola 24 pack of 12 ounce cans £6.99” and based on matching criteria, the system 100 accepts this suggestion. A subsequent search using the product long form name against the UPC database indicates that the UPC code for this product is 123456 789999 with a very high probability and it is accepted by the system 100. The search for the second product reveals two likely possibilities: 1) Alpha Cola Cherry 2 liters £1.99 or 2) Alpha Cola Cherry two pack 1 litre glass bottles £1.99. The system 100 refers the final match to a human being for verification, who confirms “Alpha Cola Cherry 2 liters £1.99” as the correct product. A subsequent search using the product long form name against the UPC database indicates that the UPC code for this product is 123456 789998 with a very high probability and it is accepted by the system 100.

The server 101 may utilise the mapping to calculate total product purchases across a plurality of providers. The server 101 may generate a benefit based upon the totalled purchases in step 207. For example, the server 101 may generate a discount offer based upon a purchase threshold being reached within a specified time period.

The server 101 may utilise the extracted information for a plurality of purchases for a user across a time period to generate behaviour predictions for the user.

The server 101 may generate a benefit for the user based, at least in part, upon the behaviour predictions for that user. For example, the server 101 may generate a discount for a product that the user purchased previously.

In generating the benefit, the server 101 may utilise current information about the user, such as the user's current location. For example, the server 101 may generate a discount for a product, or a similar product, sold in particular location, when the user is near that particular location.

The server 101 may also calculate current product ownership for a user. For example, the server 101 may predict how much of a product is currently owned by the user, such as, if a user purchased a pint of milk, the server 101 may determine that half of the milk is left after two days.

The server 101 may calculate current product ownership in accordance with one or more of the following factors: product shelf-life, multiple purchases of the same product over a timescale, household size of the user, unit size of the product, and product substitution. For example, customer ‘A’ buys one two litre container of Happy Cow Organic 2% fresh milk. ‘A’ also buys a six pack of one litre 2% long-life milk. ‘A’s purchases over a five week period are as follows:
Week one:
   1 one litre container of Happy Cow Organic 2% fresh milk;
   1 six pack of Moo 1 litre 2% long-life milk.
Week two:
   1 one litre container of Happy Cow Organic 2% fresh milk;
Week three:
   1 one litre container of ACME Supermarket brand 2% fresh milk
Week four:
   1 one litre container of Happy Cow Organic 2% fresh milk;
Week five:
   1 one litre container of ACME Supermarket brand 2% fresh milk
   1 six pack of Moo one litre 2% long-life milk.

‘A’ has indicated that there are three people in his household. Using the customer-provided purchase data points the server 101 creates a consumption prediction algorithm for the ‘Milk’ category as these products are considered to be substitutes. The consumption prediction algorithm is evaluated together with expected shelf-life of each product to estimate potential spoilage. This yields the probability whether ‘A’ needs to repurchase milk in week six and in what quantities.

Current product ownership may be used by the server 101 in generating a benefit for the user. For example, if the user is running out of a product, the server 101 may generate a discount on that product or a similar product. The system 100 may suggest a location at which to buy the product. Similarly, the system 100 may generate a reminder list of all products which the system 100 estimates the user may no longer own or which need to be replenished.

In one embodiment, the benefit provided by the server 101 is entry into a sweepstakes (including lotteries and prize draws) for the user. For example, once the system 100 has received a user's digitized receipt, the server 101 can conduct a sweepstakes draw based on any of the following parameters (individually or in combination): numbers of receipts submitted, and/or receipt contents (such as Date, Time stamp, Retailer name, Retailer location, Cashier number, Specific products, Prices associated with specific products, Quantities associated with specific products, Total amount spent, Payment method used, and Retailer loyalty program point balances i.e. open balance, qualifying purchases, points earned, closing balance, and/or retailer £ value).

A sweepstakes draw may take place against digitized receipts in the system 100 with matching criteria (as set out in the sweepstakes in effect) and winning receipt (and associated user) are selected using an electronic selection mechanism (such as a random number generator applied against receipts).

In one embodiment, the number of entries to the sweepstakes for a user is defined by the number of receipts uploaded to the server 101 and the number of friends referred on social networking sites, and the draws are held based on defined time periods, such as daily, weekly, and/or monthly.

An example of one embodiment of the invention (referred to as Shopitize) will now be described:

1) A consumer, John, goes to ALPHA Supermarket and does his weekly grocery shop;

2) John then goes to BRAVO Corner Market to pick up a few missing items;

3) While in that area, he goes next door to Retailer C to buy a new shirt.

4) Finally on his way home he fills up his car at Petrol Station D on his way home.

5) At home, he uses a Shopitize App on his mobile device to take digital pictures of the receipts (ALPHA Supermarket, BRAVO Corner Market, Petrol Station D) and the application submits those via the Internet to the Shopitize server;

6) The Shopitize server performs Optical Character Recognition (OCR) to convert the text;

7) The Shopitize System identifies retailer, product moniker, location, time, product prices, total price, discounts, coupons, taxes, loyal card used, qualifying loyalty card balance, opening balance, points earned, closing balance from the receipt;

8) The Shopitize System applies an algorithm to identify & match products across channels from the differing monikers to the long-form of the product name and ultimately to the UPC;

9) John does not have a physical receipt for Retailer C, but does have an on-line receipt. Using a web-based or downloaded tool bar, John searches for and uploads the digital receipt from his email, social networking site or phone's text messages;

10) In addition to purchase data, the Shopitize system captures:
a. Geo tag and GPS data;
b. Physical location check-in (via apps, NFC tags, QR or other machine readable codes);
c. Duration spent in specific locations;
d. Web search history;
e. Social preferences (expressed like or dislike for content);
f. Leisure preferences, activities and or memberships;
g. Customer family size and associated demographics;
h. Post code;
i. Transportation mode and or ownership; and
j. Serial numbers of appliances and or electronic devices;

11) The Shopitize System uses the captured data points and purchased items to analyze purchase and behavioural patterns. From this, elasticity of demand based on loyalty to specific product, services and retailers can be calculated;

12) From these analyses, the Shopitize System creates the following, tailored to individual users:
a. Reports:
   i. Financial spending historical summary (by category, by retailer, by time frame, by location, etc.)
   ii. Estimated spend over a given time frame;
b. Reminders:
   i. Automated Grocery list: Tells the users what products they bought last and when they need to replenish their stocks.
c. Rewards

13) The Shoptize system stores the receipts which consumers can tag, search and access via a web portal

14) Later, when John accesses the Shopitize application he notices four things:
a. The Home Grocery stock level prediction algorithm has automatically told him when he next needs to go to the grocery store and what he needs to buy;
b. He has very specific offers for specific products, services and retailers that are tailored exactly to what he likes. This was the result of the interaction of the “Purchase behaviour prediction” algorithm;
c. His offers differ when compared to his wife—even for the exact same product. This is a result of the interplay of the Loyalty Predictor and the Personalized Price Prediction algorithms; and
d. His Universal Rewards balance has been updated and he has a new set of offer for which he can redeem his points.

For Brands, service providers and retailers, Shopitize enables targeted promotions that are tailored to the individual level while safeguarding the actual identity of the consumer. The interplay of the following algorithms: Purchase behaviour prediction, Personalized Price Prediction, and Loyalty Predictor, allows targeted offers based on:
Past purchase history of own products;
Past purchase history of competitor products;
Past purchase history of correlated products, services, and or retailers;
Likelihood of future purchase (i.e. base on consumption rate)
Location
Time
Interplay with other behavioural variables
Weather conditions (i.e. matching past purchases with time and weather data);
Price elasticity (per product, retailer, time, location, etc.)

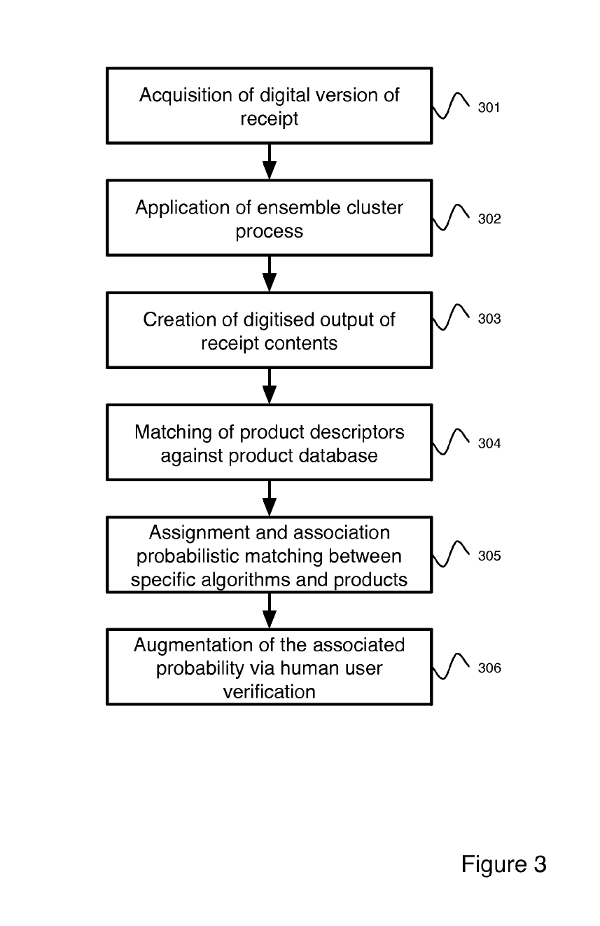

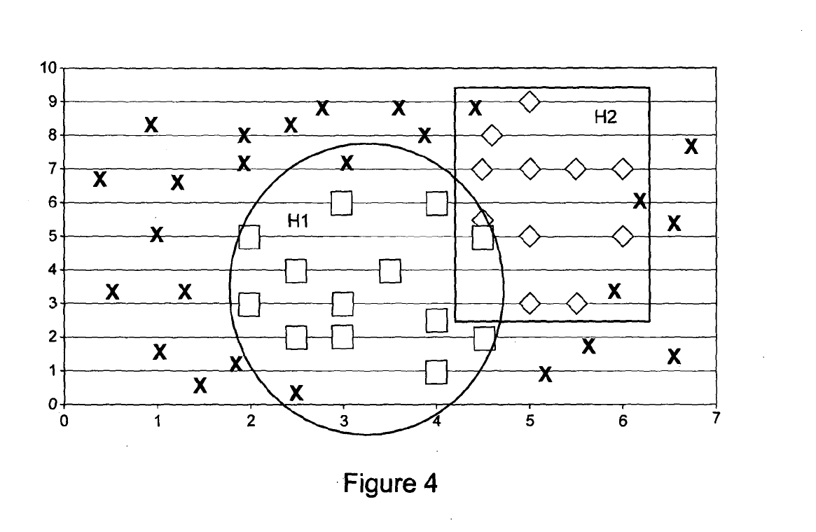

An exemplary product code matching system for use by an embodiment of the invention will now be described with reference to FIGS. 3 and 4.

This system will be referred as the Shopitize Intelligent Receipt Matching System (SIRMS)

The system is configured to perform the following steps: in step 301 the digital version of receipt is acquired.

In step 302 an ensemble cluster process is applied to the digital version of the receipt.

The general idea of ensemble clustering is to use multiple predictors and combine their results instead of attempting to build one general model to capture all the subtleties of the data.

For example, and with reference to FIG. 4, to build a model that would separate the data in FIG. 4, a hypothesis family, “H”, is formed and can separate the data using geometric shapes such as a circle (i.e. “H1”) or a square (i.e. “H2”). Visually, it can be seen that neither one by itself is sufficient. However, applying both (i.e. training two independent classifiers and merging their results—an ensemble of classifiers) provides a good approximation.

The overarching principle of ensemble techniques is to make each predictor as unique as possible: using a different learning algorithm (decision trees, svm, svd) or a different feature (random subspace method). Then, once many individual classifiers have been acquired, determining a mechanism to join the results (for example, in one simple method: each predictor votes on each point, then tally up the votes) and make a final prediction using the new classifier.

Step 302 of applying the ensemble clustering process includes the following sub-steps:

1) Receipt processed via 1 to X different OCR engines;

2) Fuzzy Search step A: OCR Output processed via stemming algorithm porters stemming, soundex or double metaphone;

3) Fuzzy search step B: String search of the matching stemmed product in product database, thus the connection between receipt and database formed.

4) The algorithms output compared on Pareto front in such way if the combination of one OCR engine and stemming algorithm produce results, better then another, in terms of large number of items matched in database, it will have higher rank, hence the more number of items from this algorithms pair will be added to the connection database and this algorithm's pair will have higher vote for its own matched items

The ensemble cluster process is not limited to the techniques described above, and may also include:
Pattern matching using Support Version Machine classifiers, where image will be directly matched to the product, without the transforming image to text
Decision trees, Random Forest to match product categories
Fuzzy k-means and c-means clustering
Evolutionary algorithms

In application, each of these techniques can be used sequentially or in parallel in contributing to the complete solution. Further, user's feedback can be incorporated into the clustering algorithms which allow such incorporation such as Evolutionary clustering algorithms, random forests etc.

In step 303 the digitized output of receipt contents are created.

In step 304 the product descriptors are matched against a Shopitize product database.

In step 305 is performed assignment and association probabilistic matching between specific algorithms and products.

In step 306, the associated probability is augmented via Shopitize or user verification.

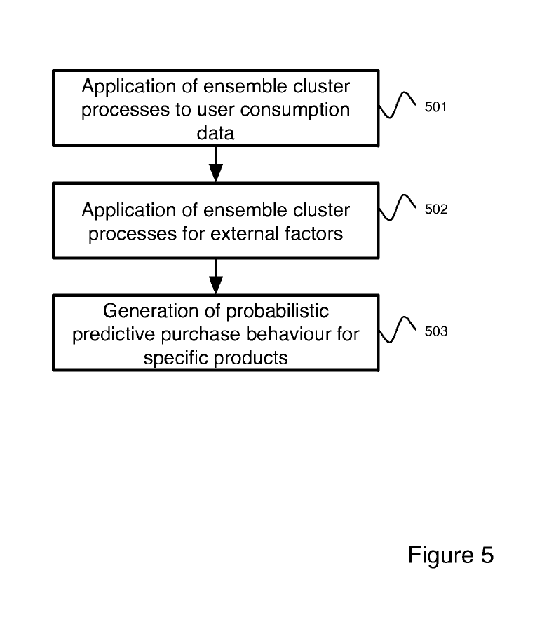

An exemplary consumption prediction algorithm for use by an embodiment of the invention will now be described with reference to FIG. 5.

The consumption prediction algorithm will be referred as Shopitize Consumption Prediction Algorithm (SCPA)

The SCPA includes step 501 of applying an ensemble cluster process on user consumption data.

The ensemble cluster process used in step 501 may include the following factors:
Consideration of all parameters that may be included on a receipt, including, but not limited to:
   Retailer
   Retailer address (including post code)
   Retailer phone number
   Retailer website
   Individual products
   Quantities associated with such products
   Prices associated with such products
   Discounts associated with such products;
   Total amount spent
   Total discounts
   Initial loyalty scheme point balance
   Additional loyalty points earned
   New total loyalty point balance
   Store number
   Time of transaction
   Payment method
   Payment details
   Cashier name or number
Historical weighting of consumer purchase history (vote, representing the performance evaluation of the previous predictive algorithm output)
User generated feedback
User information available in open sources including but not limited to social networks

In step 502 an ensemble cluster process is applied on external factors.

The ensemble cluster process used in step 502 may include any combination of the following factors:
Seasonality of product sales or availability cycle
Historic weather patterns
Predicted weather pattern
Historic events (news, sports, entertainment, etc.)
Future events (news, sports, entertainment, etc.)
News and news feeds
Historic economic data (GDP, consumption purchase index (CPI), employment/unemployment data, housing starts, manufacturing output, purchasing managers index, interest rates, exchange rates, commodity prices, consumer confidence index)
Future economic predictions (GDP, consumption purchase index (CPI), employment/unemployment data, housing starts, manufacturing output, purchasing managers index, interest rates, exchange rates, commodity prices, consumer confidence index)

The ensemble cluster is not limited to the techniques described above, and may also include:
Pattern matching using Support Version Machine classifiers, where image will be directly matched to the product, without the transforming image to text
Decision trees, Random Forest to match product categories
Fuzzy k-means and c-means clustering
Evolutionary algorithms

In application, each of these techniques can be used sequentially or in parallel in contributing to the complete solution. Further, user's feedback can be incorporating into the clustering algorithms which allow such incorporation as:
Evolutionary clustering algorithms,
random forests,
Cross-validation,
Kalman filter or variations of KF such as Uncentered Kalman Filter, The extended Kalman filter (EKF)
K-Nearest neighbours (KNN)
Weighted KNN
Inverse function
Subtraction Function
Gaussian Function
Evolutionary algorithms such as Multi-Objective, Probabilistic Selection Evolutionary Algorithms

In step 503, probabilistic predictive purchase behaviour is generated for specific products. These generated behaviours indicate the likelihood of an individual to buy:
A specific quantity
Of a specific product
In a specific context, including, but not limited to:
   Location
   Time period
   Weather conditions
   Economic environment
   Events

It will be appreciated that the present invention may be implemented as software executing on computer hardware or within hardware itself.

Potential advantages of some embodiments of the present invention is that it tracks loyalty at the individual consumer level without requiring multiple sign-ups or a physical card to be used in a retailer or at POS; enables customer purchases to be viewed in aggregate, irrespective of the retailer or service provider; analyses customer behaviour holistically across channels (i.e. retail channels); and increases consumer choice by enabling rewards to be redeemed outside of a specific retailer's scheme.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of applicant's general inventive concept.

1. A computer-implemented method of providing a loyalty program, including:
a first user providing access to a server for a plurality of receipts from a plurality of providers; and
the server processing the plurality of receipts to generate a benefit for the first user.

2. A method as claimed in claim 1 wherein the server processes the receipts to determine a sweepstake winner in accordance with a sweepstake selection process.

3. A method as claimed in claim 2 wherein each receipt is an entry to the sweepstakes.

4. A method as claimed in claim 2 wherein the sweepstake selection process includes matching criteria associated with the receipt contents.

5. A method as claimed in claim 1 wherein the server processes the receipts to extract specific product information.

6. A method as claimed in claim 5 wherein the specific product information is mapped to a universal product code.

7. A method as claimed in claim 6 wherein the specific product information is mapped to a universal product code in accordance with the following steps:
i) semantic search is performed on the Internet using the specific product information to identify expanded product information;
ii) the paired specific product information and expanded product information are stored within a database;
iii) a system facilitates human user verification and/or customer verification of the pairing; and
iv) semantic search is performed on a universal product code database using the expanded product information.

8. A method as claimed in claim 6 wherein the server generates the benefit based upon a totalling of products within the universal product code.

9. A method as claimed in claim 1 wherein the server processes the receipts to extract information of one or more selected from the set of product purchased, time of day of purchase, date of purchase, and location of purchase.

10. A method as claimed in claim 9 the method further including the step of the server further processing the extracted information to predict user behaviour.

11. A method as claimed in claim 9 the server processing the extracted information to predict user behaviour by the server analysing the extracted information in accordance with one or more features selected from the set of product selection, retailer selection, location selection, category selection, and temporal selection; wherein the server generates the benefit in accordance with predicted user behaviour.

12. A method as claimed in claim 1 wherein the benefit is a targeted offer.

13. A method as claimed in claim 9 the method further including the step of the server further processing the extracted information to determine product ownership by the user.

14. A method as claimed in claim 1 the method further including the step of the server processing the product ownership of the user in accordance with a plurality of factors to estimate product ownership at any specified time.

15. A method as claimed in claim 1 wherein the plurality of factors includes one or more selected from the set of product shelf-life, multiple purchases of the same product over a timescale, household size of the user, unit size of the product, and product substitution.

16. A method as claimed in claim 1 wherein the plurality of receipts are one or more of a receipt digitally captured by the user, or an electronic receipt provided from the provider.

17. A method as claimed in claim 1 wherein at least one of the plurality of receipts are digitally captured by the user, and the server processing the at least one receipt in accordance with the following steps:
i) performing optical character recognition on the scanned receipt to extract data;
ii) processing the data to extract product codes for at least one purchase recorded on the receipt;
iii) mapping the extracted product codes to a universal product code; and
iv) collating the universal product codes for a user to determine the extent of the benefit to be provided to the user.

18. A method as claimed in claim 1 wherein the benefits include one or more selected from the set of discounts, points redeemable against goods or services, and status.

19. A system of providing a loyalty program, including:
a first user device configured to provide access to a server for a plurality of receipts from a plurality of providers; and
a server configured to process the plurality of receipts to generate a benefit for the first user.

20. A system as claimed in claim 19 wherein the first user device is interfaced to a capture device configured to capture an image of at least one of the plurality of receipts.

21. A system as claimed in claim 19 further including a third party server configured to provide access to at least of the plurality of receipts to the server when authorised by the first user device.

22. A system as claimed in claim 19 further including an image processing system configured to extract product code information from captured images of receipts.

23. A system as claimed in claim 19 further including a product code matching system configured to match product codes within the plurality of receipts to a universal product code, and wherein the server is configured to generate the benefit based upon the matched universal product codes.

24. (canceled)

25. Computer storage medium configured to store a computer program product configured to perform the method of claim 1.
